(19) United States
(12) Patent Application Publication
(10) Pub. No.: US 2007/0138112 A1
(43) Pub. Date: Jun. 21, 2007

(54) WHEEL ROTATION DEVICE

(76) Inventors: James S. Meyer, Waterloo, IL (US); Jonathan G. Meyer, Waterloo, IL (US)

Correspondence Address: CHARLES C. MCCLOSKEY, 763 S. NEW BALLAS ROAD STE. 170, ST. LOUIS, MO, 63141, US

(21) Appl. No.: 11/613,648

(22) Filed: Dec. 20, 2006

Related U.S. Application Data
(60) Provisional application No. 60/751,904, filed on Dec. 21, 2005.

(51) Int. Cl. A47F 7/04; B65G 13/00; B60B 29/00

(52) U.S. Cl. 211/24; 193/37; 414/426

(57) ABSTRACT

A wheel rotation device assists in cleaning, inspection and maintenance of wheels. The device has a ramp, a backstop, and two contoured rollers, fastened to rails. The device operates upon a flat surface such as a garage floor or driveway, and avoids slipping from friction with the flat surface and a non-skid treatment on to the underside of the rails. The ramp allows the motorcycle to be rolled forward onto the rollers that centers the motorcycle wheel upon and between the rollers as it is manually rotated. The backstop limits forward movement of the motorcycle wheel to within the rear of the device. The rear roller, nearest the backstop, has spindles projecting through the rails and have machined ends that accept a tool to rotate the motorcycle wheel.

### CROSS REFERENCE TO RELATED APPLICATION

This non-provisional application claims priority to the provisional application Ser. No. 60/751,904 filed on Dec. 21, 2005 which is commonly owned by the same inventors.

### BACKGROUND OF THE INVENTION

The present invention relates generally to the cleaning, inspection, and maintenance of wheels, such as motorcycle wheels. Specifically, the present invention pertains to a device for rotating a wheel while mounted upon an axle without power or movement of the wheel and the use of lifting devices.

After a few miles on the road, or even off the road, motorcycle wheels accumulate dust, grime, and dirt. Riders tolerate some dust and grime upon the motorcycle wheels to show the activity of the motorcycle to others. In time, riders once again desire shiny and clean motorcycle wheels. Over a longer period of time, dust, grime, and dirt may damage a wheel or other mechanical parts and components of a motorcycle. With the desire for shiny wheels and the reluctance to damage a motorcycle, riders clean motorcycle wheels from time to time.

With minimal equipment, riders can clean wheels with soap and water from a hose, with a little brushing. However, that method sprays water well beyond the motorcycle and it also proves difficult in colder weather. This method works poorly in the confined space of a garage where overspray of water is not tolerated. Additionally, in this method, the wheels are again rotated to clean the portion hidden behind fenders and exhaust pipes.

Further rotating the wheels can be tedious and possibly injurious when done by hand. Occasionally, the axle of the wheel has to be jacked up which is less than an easy task. The front handle bars and fork turns often in the least desirable direction. Many a rider has been pinched inside of the front fork and the chassis of the motorcycle.

From time to time, motor vehicle departments and other governmental agencies require inspections of motorcycles. During an inspection, the wheels of a motorcycle are turned for visual checks by an inspector. An inspector or the rider will likely not lift either end of a motorcycle for the wheels to turn. Generally, inspection stations have dynamometers or other roller devices to permit rotation of wheels during an inspection. However, dynamometers likely exceed the budgets of individual riders and small repair shops.

Should a wheel or other mechanical part require repair, often the wheel is turned to release the chain drive or to assist in detaching the shaft drive. Unless jacked up, rotating a wheel proximate the ground is difficult by hand and potentially dangerous if a kickstand gives way or a front fork turns.

### DESCRIPTION OF THE PRIOR ART

Over the years, others have developed devices to aid for the cleaning, inspection, repair, and maintenance of wheels, particularly motorcycle wheels. The devices generally ease the rotating of a wheel without a motorcycle being upon a jack or other stand.

The prior art includes U.S. Pat. No. 5,069,348 to Edward Long and U.S. Pat. No. 6, 540,470 to Gerald Smith and Timothy Johnson. These patented devices have limited function with present day motorcycles. Present day motorcycles have greater weight that requires mechanical assistance to rotate wheels when using these patented devices.

The '348 patent describes a wheel tool that has a support for free rotation of a wheel thereof. The support has inclined ramps between side rails that lead to a plurality of transverse rollers. One side rail has additional rollers at an obtuse angle to the main gang of rollers. The additional rollers allow turning of a wheel at an angle, such as when a front wheel of a motorcycle is turned at the handlebars. The main gang of rollers and the additional rollers are shown as generally smooth, constant diameter, cylinders which may permit a wheel to slide along the cylinders, perhaps off the wheel tool.

The '470 patent shows a frame with integral front and rear ramps and rollers between the sides. These rollers are spring loaded and have their spindles ends placed in apertures in the sides. The rollers can be repositioned along the length of the frame within the sides to suit different diameter wheels. Again, these rollers are shown as smooth cylinders of constant diameter. The constant diameter permits wheels to slide upon the roller and perhaps out of the frame.

Both prior patents permit manual turning of wheels placed upon the patented devices. The patented devices though lack the mechanical assistance for rotation, or provision to apply mechanical assistance, and also do not center a wheel when placed thereupon. During usage, the patented devices elevate a wheel at a height that allows turning of the front fork which tips a motorcycle excessively. Excessive tipping causes a pronounced lean upon a kickstand which may lead to failure of the kickstand or a toppling of the motorcycle upon a rider.

The present invention overcomes the difficulty of rotating a heavy wheel without tipping, or unbalancing, a motorcycle or other wheeled vehicle. The present invention also centers a wheel upon the device and thus promoting stability of the invention and a wheel.

While the above-described devices fulfill their respective, particular objectives and requirements, the aforementioned patents do not describe a wheel rotation device that centers wheels placed thereupon and that allows for mechanically rotating wheels as needed. Therefore, a need exists for a new and improved wheel rotation device that in its structure aids in centering wheels and that accepts mechanical force or torque to aid in rotation of a wheel. The present invention substantially fulfills this need. Further, the wheel rotation device substantially departs from the conventional concepts and designs of the prior art. In doing so, the present invention provides a device primarily developed for the purpose of centering a wheel upon a gang of rollers and where at least one roller accepts mechanical power to turn a wheel placed upon the invention.

### SUMMARY OF THE INVENTION

In view of the foregoing disadvantages inherent in the known types of wheel ramps and stands, the present invention provides an improved wheel rotation device, and overcomes the disadvantages and drawbacks of the prior art. As such, the general purpose of the present invention is to provide a new and improved wheel rotation device which has all the advantages of the prior art mentioned heretofore and many novel features that result in a wheel rotation device which is not anticipated, rendered obvious, suggested, or even implied by the prior art, either alone or in any combination thereof.

In view of the limitations now present in the prior art, the present invention provides a new and useful motorcycle wheel cleaning, inspection, and maintenance device of simpler construction, of greater and wider utility, and of more versatile operations than that known in the devices of this kind.

The present invention has a support chassis constructed of an opposing left rail and right rail, connected by an inclined ramp fastened between the rails at one end and an backstop fastened between the rails at the opposing end of the device, both of which are substantially perpendicular to the rails. The rails have at least two circular recesses, generally upon the interior of the device, for receiving bearings which will accept spindles, or axles, for at least two mutually parallel and contoured rollers. The device permits a motorcycle wheel to advance upon it from one direction and track in a centered fashion upon the two parallel contoured rollers. The angled backstop limits movement of the motorcycle wheel to no further than the rear end of the device. In addition, the contoured roller proximate to the angled backstop has protruding spindles, or axles, that project through the rails and has its ends which accept a wrench, speed bar, or other tool, to provide mechanical advantage to assist in the rotation of the motorcycle wheel when placed upon the device.

The foregoing has outlined, in general, the physical aspects of the invention and has served as an aid to better understanding the detailed description. Thus, the present invention is not limited to the method or detail of construction, fabrication, material, or application of use described and illustrated herein. Any other variation of fabrication, use, or application should be considered apparent as an alternative embodiment of the present invention.

There has thus been outlined, rather broadly, the more important features of the invention in order that the detailed description thereof that follows may be better understood and in order that the present contribution to the art may be better appreciated. The wheel rotating device may also include knurling or other surface treatment upon the center of the rollers, a concave shape of the rollers, and fluting or other surface treatment of the ramp and the backstop.

Numerous objects, features and advantages of the present invention will be readily apparent to those of ordinary skill in the art upon a reading of the following detailed description of presently preferred, but nonetheless illustrative, embodiments of the present invention when taken in conjunction with the drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and devices for carrying out the several purposes of the present invention. It is important, therefore, that the claims be regarded as including such equivalent constructions insofar as they do not depart from the spirit and the scope of the present invention.

It is therefore an object of the present invention to provide a new and improved wheel rotation device.

An object of the present invention is to provide a wheel rotation device that will overcome the deficiencies of the prior art devices.

An object of the present invention is to provide a wheel rotation device that offers a low profile design requiring minimal elevation thus providing for less lean of a motorcycle while utilizing a side kickstand.

Another object of the present invention is to provide a wheel rotation device that utilizes a low elevation inclined ramp component to facilitate easy placement of a motorcycle wheel onto two parallel aligned contoured rollers.

Another object of the present invention is to provide a wheel rotation device that incorporates two machined rollers that are contoured towards the center of each roller to ensure centered tracking of a motorcycle wheel when manually rotated on the device.

Another object of the present invention is to provide a wheel rotation device that includes an backstop to restrict forward movement of the motorcycle wheel to no farther than the rear end of the device.

Another object of the present invention is to provide a motorcycle wheel cleaning, inspection and maintenance device that provides left and right side drive extensions fixed on both ends of one of the contoured rollers for mechanically assisted movement of the motorcycle wheel through the use of a separate accessory ratcheting wrench or socket type tool.

Another object of the present invention is to provide a motorcycle wheel cleaning, inspection and maintenance device that is constructed of components easily disassembled for parts replacement and service.

Another object of the present invention is to provide a motorcycle wheel cleaning, inspection and maintenance device that is designed to be compact and conveniently stored on end or wall mountable.

Another object of the present invention is to provide a motorcycle wheel cleaning, inspection and maintenance device that is constructed of durable rust resistant materials requiring minimal maintenance.

It is intended that any other advantages and objects of the present invention that become apparent or obvious from the detailed description or illustrations contained herein are within the scope of the present invention.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

In referring to the drawings,

FIG. 1 is a perspective view of a motorcycle wheel cleaning, inspection and maintenance device according to the present invention;

FIG. 2 is a side view of a motorcycle wheel cleaning, inspection and maintenance device including a representation of a motorcycle wheel resting on the device according to the present invention;

FIG. 3 is a front view of a motorcycle wheel cleaning, inspection and maintenance device according to the present invention;

FIG. 4 is a view of the contoured rollers used in a motorcycle wheel cleaning, inspection, and maintenance device according to the present invention;

FIG. 5 is a top view of a motorcycle wheel cleaning, inspection and maintenance device according to the present invention; and,

FIG. 6 describes an exploded view of the components of the present invention.

The same reference numerals refer to the same parts throughout the various figures.

### DESCRIPTION OF THE PREFERRED EMBODIMENT

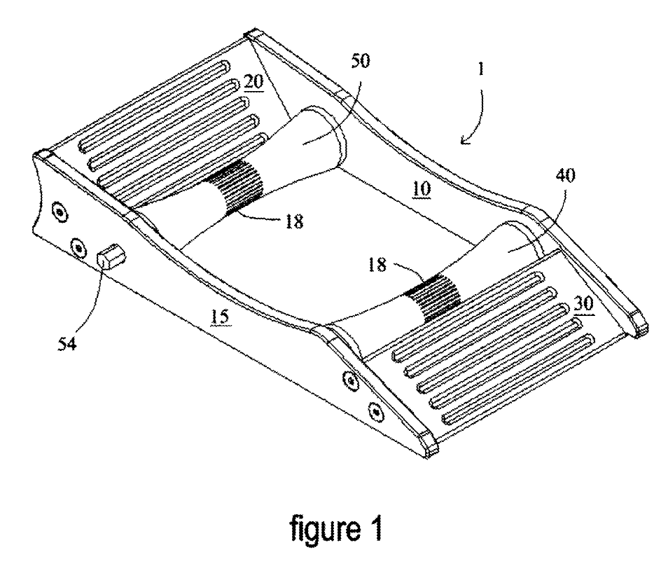

The present art overcomes the prior art limitations by providing a wheel rotation device with contoured and textured rollers that center a wheel when rotated thereupon. FIGS. 1 through 6 illustrate a motorcycle wheel rotation device 1 according to the present invention. This device is generally located and operated upon a flat surface, such as a garage floor, driveway, or roadway. A motorcycle (not shown) is manually moved forward with one wheel onto the ramp 30 which comes to rest upon and between the front roller 40 and the rear roller 50. The rollers are spaced apart and mutually parallel with their longitudinal axes generally perpendicular to the length of the device. The wheel can then be rotated by hand, or with the assistance of the integrated drive spindles, or axles 52, incorporated onto the opposing ends of the rear roller 50 situated closest to the backstop 20 for cleaning, inspection and maintenance of the motorcycle wheel and tire.

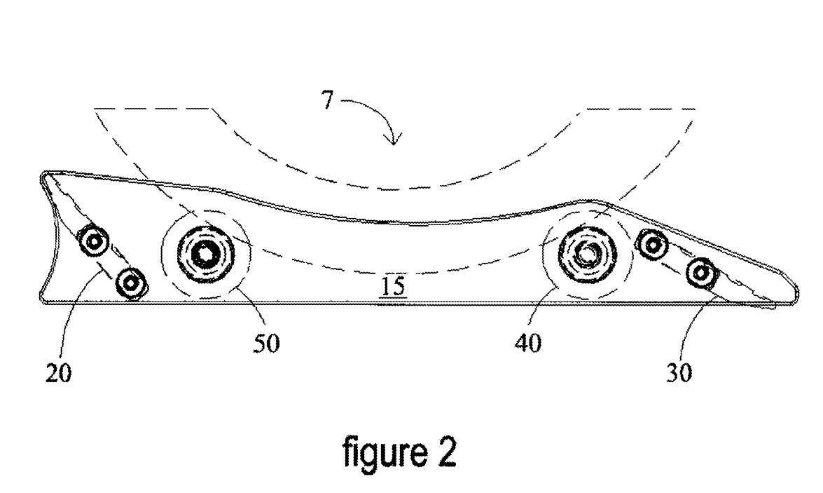

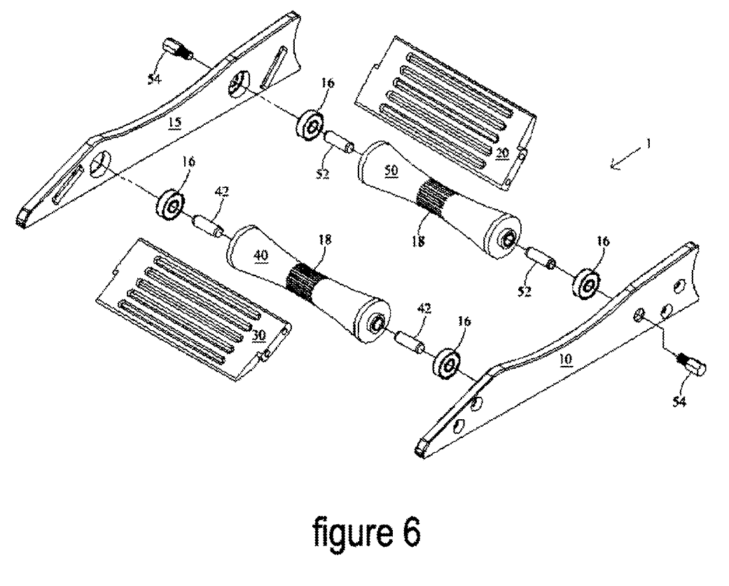

The present invention generally comprises a chassis constructed of an opposing left rail 15 and a right rail 10 joined together by a ramp 30, at an incline, fastened between the rails at the leading end, or front, of the device 1 and a backstop 20, at an incline not necessarily the same as the ramp, fastened between the left rail 15 and right rail 10 at the opposing end, or rear of the device 1. The ramp 30 and the backstop 20 are fastened substantially perpendicular to the left rail 15 and right rail 10. The left rail 15 and the right rail 10 each have two circular recesses incorporated into each of their sides defined as the interior of the device for receiving roller bearings 16 which will accept spindles, or axles 42, 52 for the front roller 40 and the rear roller 50 respectively as later shown in FIG. 6. A motorcycle wheel 7, as shown in FIG. 2, advances forward and upward onto the device and tracks in a centered fashion upon and between the rollers 40, 50 with the backstop 20 restricting movement of the motorcycle wheel to no farther than the rear of the device. In addition, the rear roller 50 has protruding spindles, or axles 52, that project through the left rail 15 and right rail 10 and have machined ends 54 which are fashioned to accept a wrench, or other tools, to assist in the rotation of a motorcycle wheel for cleaning, inspection, and maintenance.

FIG. 2 illustrates a side view of the device 1, including a wheel 7 shown in phantom, showing the positioning of a motorcycle wheel onto and between the rollers 40, 50 for the proper operation of the device. As described above, the ramp and the backstop are fastened to the left rail, here shown using bolts. Alternatively, the ramp and the backstop are welded to the left rail. Also, the rollers 40, 50 with roller bearings 16 are shown in phantom with the axles and spindles visible at the outside surface of the left rail.

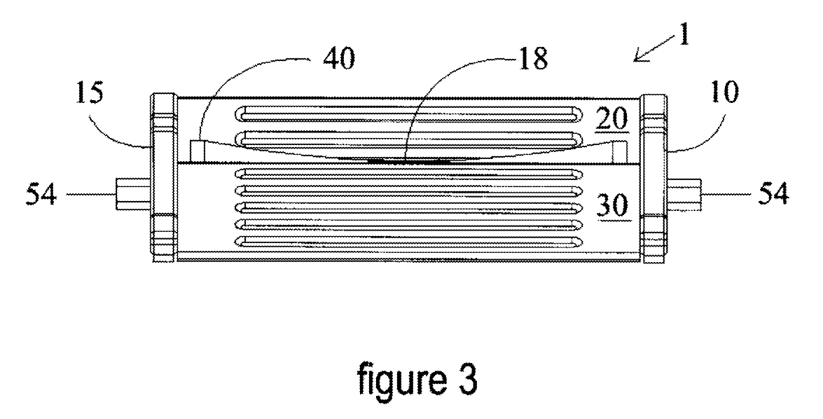

FIG. 3 represents a front view of the present invention 1 before a wheel is positioned upon it for cleaning, inspection and maintenance device. This figure illustrates the low profile of the device that allows for low ground clearance, previously shown in FIG. 2, of the wheel making it easy to roll a motorcycle on and off the device 1. The low clearance further minimizes excessive leaning of a motorcycle while resting on the side kickstand. Behind the ramp 30, the device has the front roller 40, generally round, that has a concave shape where the center has a lesser diameter than the end and a pattern of ridges 18 in the center to assist the wheel in gripping the roller and in remaining centered thereupon. Both the ramp and the backstop are shown in this viewing having a plurality of parallel, longitudinal flutes. The flutes and their associated ridges provide some grip between a wheel and the ramp and backstop when the wheel is in motion onto the device.

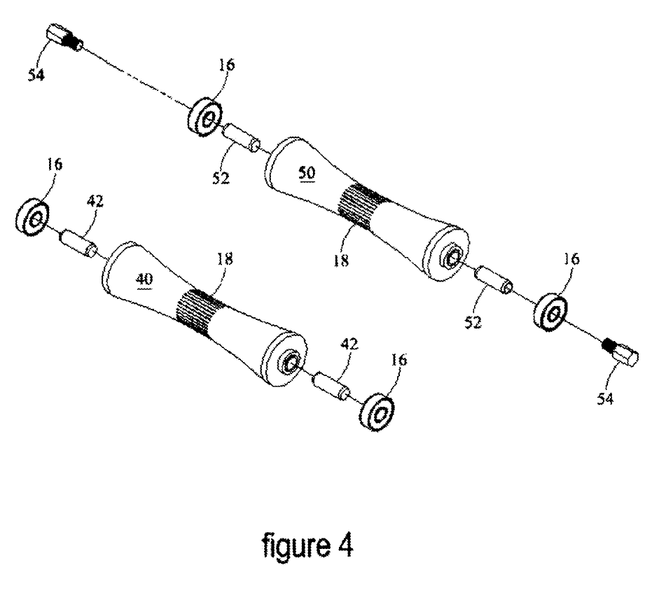

Then, FIG. 4 illustrates the front roller 40, shown to the left, and the rear roller 50, shown to the right. The front roller has two ends machined with holes to receive spindles, or axles 42. These axles 42 have closed ends that fit into the center of bearings 16 which themselves fit into the sides 10, 15. The rear roller 50 also has two ends machined with holes that receive spindles 52. These spindles have one open end that accepts a machined end 54. In assembly of the device, the open end of each spindle is inserted into a bearing 16 for each side 10, 15 and then the machined end 54 is attached. The machined end has a hex, or other, shaped head that accepts a wrench, or other tool, that supplies mechanical advantage to turning the rear roller 50 and thus the wheel 7 placed thereupon.

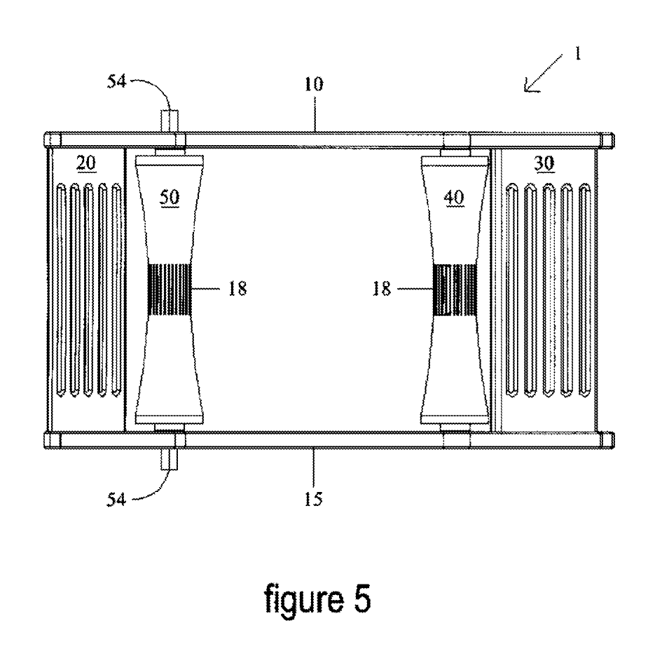

FIG. 5 shows a top view of the present invention. The device 1 has two parallel and spaced apart rails 10,15. The rails are connected by a ramp 30 at the front of the device, here right, and a backstop 20 at the rear of the device, here left. The ramp and the backstop are inclined with the higher edge towards the right in this figure. In this embodiment, the ramp and the backstop both have fluting and associated ridges for nearly their own lengths. The ridges assist a tire in gripping the ramp and the backstop when a tire contacts them. Further, the ridges on the ramp assist a tire upwards and onto the front roller 40. The front roller spans across the device and between the rails. The front roller has a generally round cross section that narrows in a concave manner towards the center, proximate to the grooves or knurling as at 18. The concavity and knurling of the front roller assist a tire placed thereupon to remain centered upon the roller during movement of the tire, the roller, or both. The roller mounts upon spindles that engage a bearing within the sides as previously described. The rear roller 50 is similar to the front roller 40 but for its spindles. The spindles in the rear roller accept machined ends 54 that pass through the bearings in the sides towards the rear. The machined ends have a shape that receives wrenches, sockets, or other tools that provide mechanical turning to the rear roller and any tire or wheel placed thereupon. The concavity and knurling of the rear roller as at 18 assist a tire in gripping the rear roller and the rear roller in transferring rotation to any wheel upon it.

An exploded view of the device appears in FIG. 6. The device has two rails, 10,15 generally mirror images of each other. Upon the interior face of the rails, each has slots to accept the ramp and the backstop respectively and spaced apart and recessed openings to accept the bearings 16. The ramp 30 attaches to the slots in the sides 10, 15 with mechanical fasteners in the preferred embodiment. Alternatively, the ramp is welded to the rails. The front roller 40 has apertures in each end that receive axles 42. The axles pass into the bearings 16 which fit into recesses in the sides. Spaced rearward and with a parallel longitudinal axis to the front roller, the rear roller also has apertures that receive axles 52. The axles have an end that passes through the bearings 16 and receives a machined end 54. The machined end connects to the axle in such a manner so that the machined end can be rotated clockwise or counter clockwise without disconnecting from the axle. As before, the front roller and the rear roller have a generally cylindrical shape where the diameter reduces towards the center, forming a concave shape and the location for the grooves or knurling 18 that assist the grip of a tire when placed upon the rollers. And the backstop 20 attaches to the rearward slots at a steeper angle than the ramp. The backstop preferably attaches to the sides with mechanical fasteners while welding remains an alternative connection means. With the backstop incline more so than the ramp, a wheel generally enters the device upon the ramp and is removed from the device over the ramp. A wheel can only enter the device from the front and does not turn over the backstop during general usage.

Though the present invention is described for motorcycle wheel cleaning, inspection and maintenance, it can be used to clean, inspect and maintain the wheels on various other vehicles: scooters, mopeds, motorbikes, all terrain vehicles, trailers, tractors, and some automotive vehicles.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

From the aforementioned description, a wheel rotation device has been described. The wheel rotation device is uniquely capable of centering a wheel placed upon a pair of rollers within a frame. The wheel rotation device and its various components may be manufactured from many materials, including but not limited to aluminum, steel, polymers, high density polyethylene, nylon, ferrous and non-ferrous metals, their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A device for rotating wheels and tires placed thereupon comprising:
two mutually parallel and spaced apart rails, each of said rails having a front, an opposite rear and a bottom;
a ramp locating between said rails towards said front and at an incline upwardly from said bottom;
a backstop locating between said rails towards said rear and at an incline upwardly from said bottom;
a front roller located inwardly from said ramp, said front roller having a gripping surface generally centered thereon, said front roller connecting to two spaced apart bearings seated into said rails; and,
a rear roller locating inwardly from said backstop, generally parallel to said front roller, said rear roller having a gripping surface generally centered thereon, connecting through two spaced apart bearings seated into said rails, and said roller having at least one end adapted to receive a tool.

2. The wheel and tire rotating device of claim 1 further comprising:
said front roller, generally cylindrical, and having a concave shape from the diameter of said front roller narrowing towards the center of said front roller, said gripping surface locating proximate the narrowest diameter of said front roller.

3. The wheel and tire rotating device of claim 1 further comprising:
said rear roller, generally cylindrical, and having a concave shape from the diameter of said rear roller narrowing towards the center of said rear roller, said gripping surface locating proximate the narrowest diameter of said rear roller.

4. The wheel and tire rotating device of claim 1 further comprising:
said rear roller having at least one spindle joining to said at least one end, and a machined end joining to and coaxial with said at least one spindle, said machined end adapted to receive a tool.

5. The wheel and tire rotating device of claim 4 wherein said machined end is a hex head.

6. The wheel and tire rotating device of claim 1 further comprising:
said front roller having two opposite ends, and an axle joining to each of said ends, said axles being coaxial with said front roller and seating into said bearings.

7. The wheel and tire rotating device of claim 1 further comprising:
said backstop being at a greater incline than the incline of said ramp, and said backstop being at a higher elevation upon said rails than said ramp.

8. The wheel and tire rotating device of claim 1 further comprising:
said ramp having a surface treatment to prevent skidding by said wheel when placed thereon and said backstop having a surface treatment to prevent skidding by said wheel when placed thereon.

9. The wheel and tire rotating device of claim 1 wherein said rails are mirror images and said device is symmetric about the longitudinal axis.

10. A wheel turning device moved by hand, or light tools, comprising:
at least two mutually parallel and spaced apart rollers, including a front roller and a rear roller, said front roller having a gripping surface generally centered thereon and said rear roller having a gripping surface generally centered thereon and at least one end adapted to receive a tool;
a ramp locating generally parallel to said front roller and outwardly of said front roller, and at an incline upwardly from the horizon;
a backstop locating generally parallel to said rear roller and outwardly of said rear roller, and at an incline upwardly from the horizon; and,
two mutually parallel and spaced apart rails, generally perpendicular to said rollers, each of said rails having a front and an opposite rear, said ramp locating proximate said front, said backstop locating proximate said rear, and said rollers locating between said ramp and said backstop.

11. The wheel turning device of claim 10 further comprising:
said front roller being generally cylindrical, and having a concave shape where the diameter narrows towards the center of said front roller and having a gripping surface generally centered upon said front roller; and,
said rear roller being generally cylindrical, and having a concave shape where the diameter narrows towards the center of said front roller and having a gripping surface generally centered upon said rear roller.

12. A wheel turning device moved by hand, or light tools, comprising:
a frame having two mutually parallel and spaced apart rails, a ramp within said rails and locating perpendicular to said rails, a backstop locating within said rails and locating perpendicular to said rails generally opposite said ramp;
at least two mutually parallel and spaced apart rollers, including a front roller and a rear roller, said front roller having a gripping surface generally centered thereon and said rear roller having a gripping surface generally centered thereon and at least one end adapted to receive a tool;
said ramp having an upward incline; and,
said backstop having an upward incline.

13. The wheel turning device of claim 12 further comprising:
said front roller being generally cylindrical, and having a concave shape and a gripping surface generally centered upon said front roller; and,
said rear roller being generally cylindrical, and having a concave shape and a gripping surface generally centered upon said rear roller.
